(19) United States
(12) Patent Application Publication
(10) Pub. No.: US 2011/0249676 A1
(43) Pub. Date: Oct. 13, 2011

(54) Method and System for Forwarding and Switching Traffic in a Network Element

(76) Inventors: Bijendra Singh, Plano, TX (US); Vibha Sarin, Plano, TX (US); Hong Li, Plano, TX (US); Chandra Ganesh, Murphy, TX (US)

(21) Appl. No.: 12/757,165

(22) Filed: Apr. 9, 2010

(51) Int. Cl. H04L 12/56

(52) U.S. Cl. 370/395.32

(57) ABSTRACT

A method for forwarding a packet may include generating, by a first hash function module, a first hash value based on data included within the packet. The method may also include generating, by a second hash function module, a second hash value based on data included within the packet. The method may additionally include determining, by a first hash region integral to a memory and associated with the first hash function module, whether an index location of the first hash region corresponding to the first hash value includes an entry. Moreover, the method may include determining, by a second hash region integral to a memory and associated with the second hash function module, whether an index location of the second hash region corresponding to the second hash includes an entry. The method may further include, in response to a determination that at least one of the index location of the first hash region corresponding to the first hash value and the index location of the second hash region corresponding to the second hash value includes an entry, forwarding the packet based on forwarding information included within the entry.

### TECHNICAL FIELD OF THE INVENTION

The present invention relates generally to networked communications and, more particularly, to a method and system for forwarding and switching network traffic in a network element.

### BACKGROUND

In telecommunications, information is often sent, received, and processed according to the Open System Interconnection Reference Model (OSI Reference Model or OSI Model). In its most basic form, the OSI Model divides network architecture into seven layers which, from top to bottom, are the Application, Presentation, Session, Transport, Network, Data-Link, and Physical Layers, which are also known respectively as Layer 7 (L7), Layer 6 (L6), Layer 5 (L5), Layer 4 (L4), Layer 3 (L3), Layer 2 (L2), and Layer 1 (L1). It is therefore often referred to as the OSI Seven Layer Model.

Layer 2 is the layer which typically transfers data between adjacent network nodes in a wide area network or between nodes on the same local area network segment. Layer 2 provides the functional and procedural means to transfer data between network entities and might provide the means to detect and possibly correct errors that may occur in the Layer 1. Examples of Layer 2 protocols are Ethernet for local area networks (multi-node), the Point-to-Point Protocol (PPP), HDLC and ADCCP for point-to-point (dual-node) connections. Layer 2 data transfer may be handled by devices known as switches.

Layer 3 is responsible for end-to-end (source to destination) packet delivery including routing through intermediate hosts, whereas the Layer 2 is responsible for node-to-node (e.g., hop-to-hop) frame delivery on the same link. Perhaps the best known example of a Layer 3 protocol is Internet Protocol (IP). Layer 3 data transfer may be handled by devices known as routers.

A particular network element (e.g., a switch or a router) may forward network traffic based on contents of a forwarding table resident upon the network element that associates unique identifiers (e.g., addresses such as MAC addresses and IP addresses) of other network elements coupled to the particular network element to egress interfaces of the particular network element. Thus, in order to determine the proper egress interface to which an ingress interface should forward traffic to be transmitted by the network element, logic of the network element may examine the traffic to determine a destination address for the traffic, and then perform a lookup in the forwarding table to determine the egress interface associated with such destination address.

Traditionally, forwarding tables in network elements are often implemented using either ternary content-addressable memories (TCAMs) or multi-bucket hash tables, each of which has disadvantages.

For TCAM implementations, the TCAM is typically searched using a key in a parallel lookup in order to provide for quick lookup. However, for this reasons, TCAMs are often prohibitively expensive because extensive hardware is required to support such parallel lookup.

For multi-bucket hash tables are somewhat less expensive, but have their own drawbacks. For example, when all bits for multiple buckets for a hash key are aggregated, the total bit length often becomes very long, making multi-bucket hash tables difficult to implement for fast lookup speeds. In addition, maximum utilization for such multi-bucket has tables is typically around 55% due to hash collisions, meaning 45% of the memory allocated for the forwarding table essentially goes unused.

### SUMMARY

In accordance with the present invention, disadvantages and problems associated with traditional approaches to switching and routing of network traffic may be reduced or eliminated.

A method for forwarding a packet may include generating, by a first hash function module, a first hash value based on data included within the packet. The method may also include generating, by a second hash function module, a second hash value based on data included within the packet. The method may additionally include determining, by a first hash region integral to a memory and associated with the first hash function module, whether an index location of the first hash region corresponding to the first hash value includes an entry. Moreover, the method may include determining, by a second hash region integral to a memory and associated with the second hash function module, whether an index location of the second hash region corresponding to the second hash includes an entry. The method may further include, in response to a determination that at least one of the index location of the first hash region corresponding to the first hash value and the index location of the second hash region corresponding to the second hash value includes an entry, forwarding the packet based on forwarding information included within the entry.

Certain embodiments of the invention may provide one or more technical advantages. For example, methods and systems disclosed herein may provide lower-cost, lower-power, and easier-to-implement solutions to those traditionally implemented.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram of an example network, in accordance with certain embodiments of the present disclosure;

FIG. 2 illustrates a block diagram an example network element, in accordance with certain embodiments of the present disclosure;

FIG. 3 illustrates a block diagram of an example forwarding table, in accordance with certain embodiments of the present disclosure;

FIG. 4 illustrates a flow chart of an example method for inserting an entry into a forwarding table, in accordance with certain embodiments of the present disclosure; and

FIG. 5 illustrates a flow chart of an example method for searching for an entry in forwarding table, in accordance with certain embodiments of the present disclosure.

### DETAILED DESCRIPTION

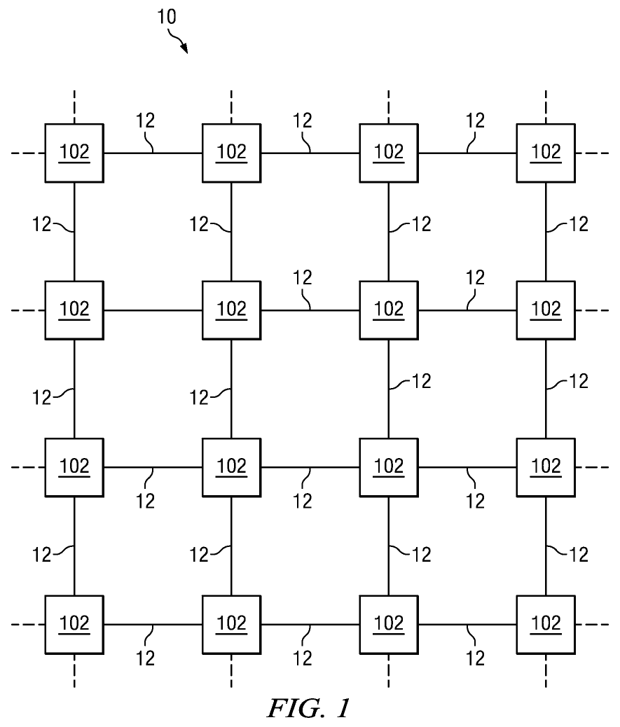

Embodiments of the present invention and its advantages are best understood by referring to FIGS. 1-5, like numerals being used for like and corresponding parts of the various drawings.

FIG. 1 illustrates a block diagram of an example network 10, in accordance with certain embodiments of the present disclosure. In certain embodiments, network 10 may be an Ethernet network. Network 10 may include one or more transmission media 12 operable to transport one or more signals communicated by components of network 10. The components of network 10, coupled together by transmission media 12, may include a plurality of network elements 102. In the illustrated network 10, each network element 102 is coupled to four other nodes to create a mesh. However, any suitable configuration of any suitable number of network elements 102 may create network 10. Although network 10 is shown as a mesh network, network 10 may also be configured as a ring network, a point-to-point network, or any other suitable network or combination of networks. Network 10 may be used in a short-haul metropolitan network, a long-haul inter-city network, or any other suitable network or combination of networks. Network 10 may represent all or a portion of a short-haul metropolitan network, a long-haul inter-city network, and/or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, or other suitable medium.

Network 10 may communicate information or “traffic” over transmission media 12. As used herein, “traffic” means information transmitted, stored, or sorted in network 10. Such traffic may comprise optical or electrical signals configured to encode audio, video, textual, and/or any other suitable data. The data may also be real-time or non-real-time. Traffic may be communicated via any suitable communications protocol, including, without limitation, the Open Systems Interconnection (OSI) standard and Internet Protocol (IP). Additionally, the traffic communicated in network 10 may be structured in any appropriate manner including, but not limited to, being structured in frames, packets, or an unstructured bit stream. As used herein, the term “packet” will be used to generally referred to any data structure used to convey traffic, including without limitation a packet, a frame, an unstructured bit stream, or any other suitable data structure.

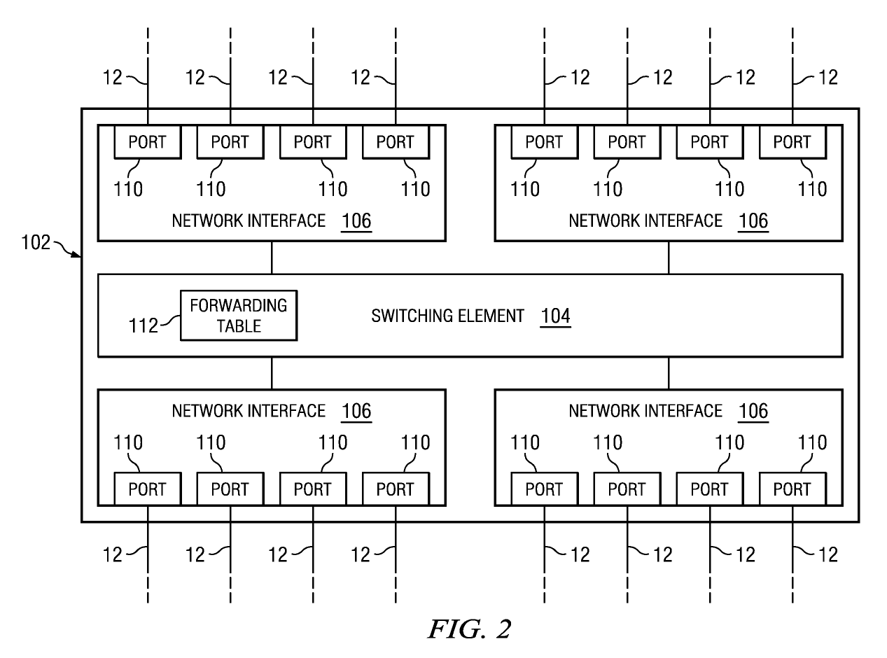

Each network element 102 in network 10 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

Modifications, additions, or omissions may be made to network 10 without departing from the scope of the disclosure. The components and elements of network 10 described may be integrated or separated according to particular needs. Moreover, the operations of network 10 may be performed by more, fewer, or other components.

FIG. 2 illustrates a block diagram an example network element 102, in accordance with certain embodiments of the present disclosure. As discussed above, each network element 102 may be coupled to one or more other network elements 102 via one or more transmission media 12. Each network element 102 may generally be configured to receive data from and/or transmit data to one or more other network elements 102. In certain embodiments, network element 102 may comprise a switch or router configured to route data received by network element 102 to another device (e.g., another network element 102) coupled to network element 102.

As depicted in FIG. 2, a switching element 104, and one or more network interfaces 106 communicatively coupled to switching element 104.

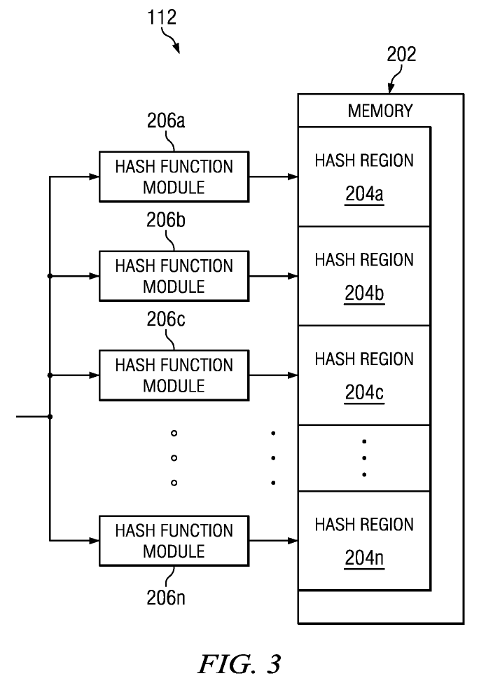

Switching element 104 may include any suitable system, apparatus, or device configured to receive traffic via a port 110 and forward such traffic to a particular network interface 106 and/or port 110 based on analyzing the contents of the data and/or based on a characteristic of a signal carrying the data (e.g., a wavelength and/or modulation of the signal). For example, in certain embodiments, a switching element 104 may include a switch fabric (SWF). As depicted in FIG. 2, switching element 104 may include forwarding table 112, which may also be used by switching element 104 to forward traffic. Forwarding table 112 may include a table, map, database, or other data structure for associating each port 110 of network element 102 with one or more other network entities (e.g., other network elements 102). Characteristics and functionality of forwarding table 112 are discussed in greater detail below in reference to FIGS. 3-5.

Each network interface 106 may be communicatively coupled to switching element 104 and may include any suitable system, apparatus, or device configured to serve as an interface between a network element 102 and a transmission medium 12. Each network interface 106 may enable its associated network element 102 to communicate to other network elements 102 using any suitable transmission protocol and/or standard. Network interface 106 and its various components may be implemented using hardware, software, or any combination thereof. For example, in certain embodiments, one or more network interfaces 106 may include a network interface card. In the same or alternative embodiments, one or more network interfaces 106 may include a line card.

As depicted in FIG. 2, each of network interfaces 106 may include one or more physical ports 110. Each physical port 110 may include any system, device or apparatus configured to serve as a physical interface between a corresponding transmission medium 12 and network interface 106. For example, a physical port may comprise an Ethernet port, an optical port, or any other suitable port.

FIG. 3 illustrates a block diagram of an example forwarding table 112, in accordance with certain embodiments of the present disclosure. As shown in FIG. 3, forwarding table 112 may include a memory 202 and a plurality of hash function modules 206 (e.g., hash function modules 206a, 206b, 206c, . . . 206n).

Memory 202 may comprise any system, device, or apparatus configured to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, solid state storage, or any suitable selection and/or array of volatile or non-volatile memory that retains data after power to network element 102 is turned off. As shown in FIG. 3, memory 202 may be segmented or divided into a plurality of hash regions 204 (e.g., hash regions 204a, 204b, 204c, . . . 204n). In some embodiments, each hash region 204 may be of approximately equal capacity. In the some or alternative embodiments, the capacity of each hash region 204 may be approximately equal to the overall capacity of memory 202 divided by the number of hash regions 204.

Each hash function module 206 may be associated with a corresponding hash region 204 (e.g., hash function module 206a may be associated with hash region 204a, hash function module 206b may be associated with hash region 204b, and so on). A hash function module 206 may include any system, device, or apparatus configured to implement a procedure and/or mathematical function that converts a large, possibly variable-sized amount of data (e.g., a network element destination address of packet or frame of traffic) a into a smaller datum called a hash value that may serve as an index to an array. In embodiments of the present disclosure, a hash value produced by a hash function module 206 may serve as an index (e.g., an address) to such hash function module's associated hash region 204. In addition, in some embodiments of the present disclosure, each of hash function modules 206 may perform a different hash function.

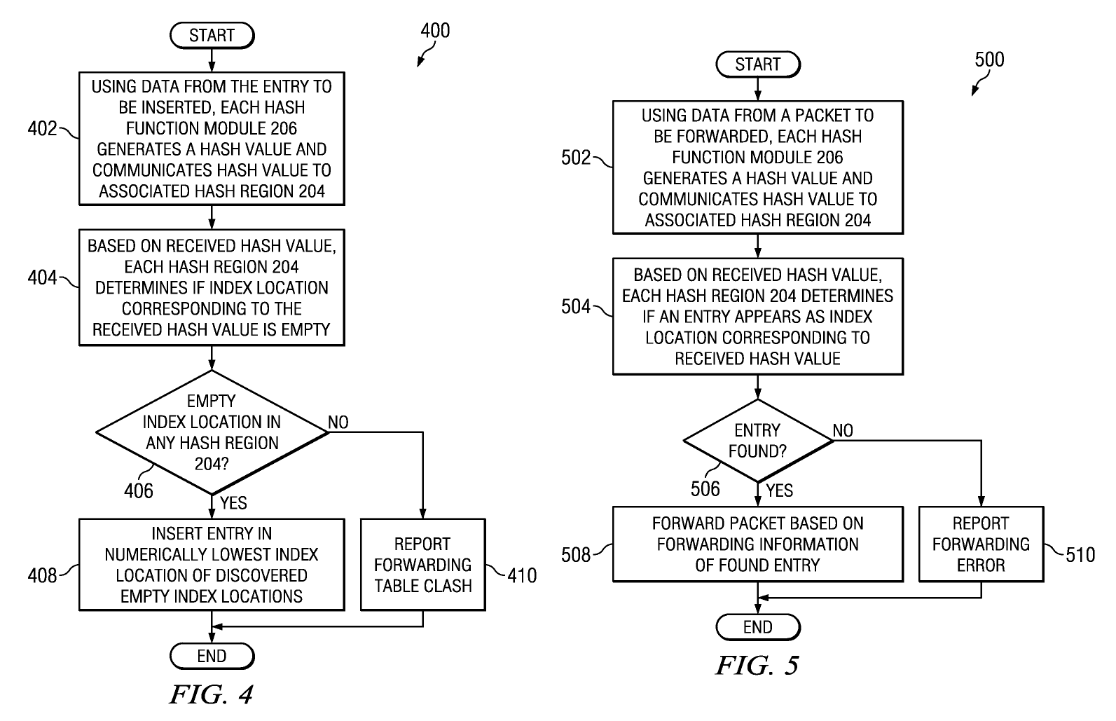

FIG. 4 illustrates a flow chart of an example method 400 for inserting an entry into forwarding table 112, in accordance with certain embodiments of the present disclosure. According to some embodiments, method 400 may begin at step 402. As noted above, teachings of the present disclosure may be implemented in a variety of configurations of network 10. As such, the preferred initialization point for method 400 and the order of the steps 402-410 comprising method 400 may depend on the implementation chosen.

At step 402, each hash function module 206 may, using data (e.g., destination address) from the entry to be inserted, may generate a hash value and communicate such hash value to its associated hash region 204.

At step 404, each hash region 204 may, based on the hash value received from its associated hash function module 206, determine if an index location of the hash region 204 corresponding to the received hash value is empty.

At step 406, memory 202 or another component of network element 102 may determine if any empty index locations were found in any hash regions 204 based on the various hash values received from the various hash function modules 206. If at least one empty index location is found, method 400 may proceed to step 408. Otherwise, method 400 may proceed to step 410.

At step 408, in response to a determination that at least one empty index location was found in a hash region 204 based on the various hash values received from the various hash function modules 206, the entry may be inserted into one of the discovered empty index locations. The selection of which empty index location to insert the entry may be made in any suitable manner. For example, in some embodiments, the entry may be inserted into the numerically lowest index location (e.g., lowest memory address of memory 202) of the discovered empty index locations. After completion of step 408, method 400 may end.

At step 410, in response to a determination that no one empty index locations were found in a hash region 204 based on the various hash values received from the various hash function modules 206, memory 202 or another component of network element 102 may communicate a message or other indication that an unresolvable clash exists in forwarding table 112. After completion of step 410, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using network element 102 or any other system operable to implement method 400. In certain embodiments, method 400 may be implemented partially or fully in software and/or firmware embodied in a memory or other computer-readable media.

FIG. 5 illustrates a flow chart of an example method 500 for searching for an entry in forwarding table 112, in accordance with certain embodiments of the present disclosure. According to some embodiments, method 500 may begin at step 502. As noted above, teachings of the present disclosure may be implemented in a variety of configurations of network 10. As such, the preferred initialization point for method 500 and the order of the steps 502-510 comprising method 500 may depend on the implementation chosen.

At step 502, each hash function module 206 may, using data (e.g., destination address) from the packet to be forwarded, may generate a hash value and communicate such hash value to its associated hash region 204.

At step 504, each hash region 204 may, based on the hash value received from its associated hash function module 206, determine if an entry exists at the index location of the hash region 204 corresponding to the received hash value.

At step 506, memory 202 or another component of network element 102 may determine if an entry is found. In certain embodiments, only one entry may be found among all of the hash regions 204 because, in such embodiments, insertion of entries were only inserted into one of the hash regions 204. If an entry is found, method 500 may proceed to step 508. Otherwise, method 500 may proceed to step 510.

At step 508, in response to a determination that at an entry was found in a hash region 204 based on the various hash values received from the various hash function modules 206, the packet may be forwarded based on forwarding information (e.g., an identification of an egress port 110) included within the found entry. After completion of step 508, method 500 may end.

At step 510, in response to a determination that no entry was found in a hash region 204 based on the various hash values received from the various hash function modules 206, memory 202 or another component of network element 102 may communicate a message or other indication that a forwarding error has occurred. After completion of step 510, method 500 may end.

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Method 500 may be implemented using network element 102 or any other system operable to implement method 500. In certain embodiments, method 500 may be implemented partially or fully in software and/or firmware embodied in a memory or other computer-readable media.

A component of network 10 and/or a network element 102 may include an interface, logic, memory, and/or other suitable element. An interface receives input, sends output, processes the input and/or output, and/or performs other suitable operations. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 10 and/or a network element 102 without departing from the scope of the invention. The components of network 10 and/or network element 102 may be integrated or separated. Moreover, the operations of network 10 and/or network element 102 may be performed by more, fewer, or other components. Additionally, operations of network 10 and/or a network element 102 may be performed using any suitable logic. As used in this document, “each” refers to each member of a set or each member of a subset of a set.

Certain embodiments of the invention may provide one or more technical advantages. A technical advantage of one embodiment may be that overcome the limitations and disadvantages of traditional approaches to forwarding table implementation, such as disadvantages present in TCAMs and multi-bucket hash tables.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for populating a forwarding table comprising:
generating, by a first hash function module, a first hash value based on data included within an entry to be inserted into a forwarding table;
generating, by a second hash function module, a second hash value based on data included within the entry to be inserted into the forwarding table;
determining, by a first hash region integral to a memory and associated with the first hash function module, whether an index location of the first hash region corresponding to the first hash value is empty;
determining, by a second hash region integral to a memory and associated with the second hash function module, whether an index location of the second hash region corresponding to the second hash value is empty; and
in response to a determination that at least one of the index location of the first hash region corresponding to the first hash value and the index location of the second hash region corresponding to the second hash value is empty, inserting the entry into one of the empty index locations.

2. A method according to claim 1, further comprising, in response to a determination that neither of the index location of the first hash region corresponding to the first hash value and the index location of the second hash region corresponding to the second hash value is empty, communicating an indication of a forwarding table clash.

3. A method according to claim 1, further comprising, in response to a determination that both of the index location of the first hash region corresponding to the first hash value and the index location of the second hash region corresponding to the second hash value are empty:
selecting one of the empty index locations for insertion; and
inserting the entry into the selected index location.

4. A method according to claim 3, wherein selecting one of the empty index locations includes selecting the empty index location with the numerically lower index location.

5. A method according to claim 1, wherein the first hash function module performs a different hash function than the second hash function module.

6. A method according to claim 1, wherein the first hash region and the second hash region are of approximately equal capacity.

7. A method for forwarding a packet, comprising:
generating, by a first hash function module, a first hash value based on data included within the packet;
generating, by a second hash function module, a second hash value based on data included within the packet;
determining, by a first hash region integral to a memory and associated with the first hash function module, whether an index location of the first hash region corresponding to the first hash value includes is populated;
determining, by a second hash region integral to a memory and associated with the second hash function module, whether an index location of the second hash region corresponding to the second hash includes is populated; and
in response to a determination that at least one of the index location of the first hash region corresponding to the first hash value and the index location of the second hash region corresponding to the second hash value is populated, forwarding the packet based on forwarding information included within an entry included at a populated index location.

8. A method according to claim 7, further comprising, in response to a determination that neither of the index location of the first hash region corresponding to the first hash value and the index location of the second hash region corresponding to the second hash value is populated, communicating an indication of a forwarding error.

9. A method according to claim 1, wherein the first hash function module performs a different hash function than the second hash function module.

10. A method according to claim 1, wherein the first hash region and the second hash region are of approximately equal capacity.

11. A method according to claim 1, wherein the data included within the packet includes the destination address of the packet.

12. A method according to claim 1, wherein the entry includes identification of an egress port.

13. A network element, comprising:
a forwarding table comprising:
a first hash function module configured to generate a first hash value based on data received at the network element;
a second hash function module configured to generate a second hash value based on the data received at the network element; and
a memory communicatively coupled to the first hash function module and the second hash function module, the memory comprising:
a first hash region; and
a second hash region;
logic for determining whether an index location of the first hash region corresponding to the first hash value is populated;
logic for determining whether an index location of the second hash region corresponding to the first hash second is populated;
logic for, in response to a determination that at least one of the index location of the first hash region corresponding to the first hash value and the index location of the second hash region corresponding to the second hash value is not populated, inserting an entry into one of the unpopulated index locations; and
logic for, in response to a determination that at least one of the index location of the first hash region corresponding to the first hash value and the index location of the second hash region corresponding to the second hash value is populated, forwarding a packet based on forwarding information included within an entry included at a populated index location.

14. A network element according to claim 13, further comprising logic for, in response to a determination that both the index location of the first hash region corresponding to the first hash value and the index location of the second hash region corresponding to the second hash value are populated, communicating an indication of a forwarding table clash.

15. A network element according to claim 13, further comprising logic for, in response to a determination that both of the index location of the first hash region corresponding to the first hash value and the index location of the second hash region corresponding to the second hash value are unpopulated:
selecting one of the unpopulated index locations for insertion; and
inserting the entry into the selected index location.

16. A network element according to claim 15, wherein selecting one of the unpopulated index locations includes selecting the unpopulated index location with the numerically lower index location.

17. A network element according to claim 13, further comprising, logic for, in response to a determination that neither of the index location of the first hash region corresponding to the first hash value and the index location of the second hash region corresponding to the second hash value is populated, communicating an indication of a forwarding error.

18. A network element according to claim 13, wherein the data included within the packet includes the destination address of the packet.

19. A network element according to claim 13, wherein the entry included at a populated index location includes identification of an egress port.

20. A network element according to claim 13, wherein the first hash function module performs a different hash function than the second hash function module.

21. A network element according to claim 13, wherein the first hash region and the second hash region are of approximately equal capacity.
